(19) United States
(12) Patent Application Publication
(10) Pub. No.: US 2004/0215522 A1
(43) Pub. Date: Oct. 28, 2004

(54) Process optimization system

(76) Inventor: Jeff Scott Eder, Mill Creek, WA (US)

Correspondence Address: JEFF EDER, 19108 30TH DRIVE SE, MILL CREEK, WA, 98012, US

(21) Appl. No.: 10/025,794

(22) Filed: Dec. 26, 2001

(51) Int. Cl. G06F 17/60

(52) U.S. Cl. 705/26

(57) ABSTRACT

An automated system (100) and method for optimizing process risk and return from the perspective of the process owner. The process, process features and feature options are defined using process management system data. The expected process outputs are then mapped to matrices of value and risk for the owner. The system then identifies the mix of features and feature options that maximize expected process value from the perspective of the owner. The system also identifies the mix of features and feature options that maximize expected process value while minimizing process risk for other frames.

### BACKGROUND OF THE INVENTION

This invention relates to a computer based method of and system for optimizing processes in a manner that maximizes expected returns while minimizing risk for the enterprise or multi-enterprise organization that owns the process.

The Internet has had many profound effects on global commerce. The explosion of e-commerce, the rapid appearance and growth of on-line business to business exchanges, and the meteoric rise in the market value of Internet firms like VerticalNet, Amazon.com and EBay are some of the more visible examples of the impact it has had on the American economy. Unfortunately, the rapid rise in sales and market value for many of the “dot com” companies has been followed an even more rapid increase in operating losses and more recently declining market values. While dozens of observers have suggested hundreds of reasons to explain the decline in the fortunes and prospects of many of the “dot com” companies started in the late 1990's in the U.S., two explanations are consistently mentioned by almost all observers:

1) The “dot com” companies have, for the most part, failed to generate profits and positive cash flow from their operations; and

2) Too many of the “dot com” companies have failed to establish solid processes for fulfilling the orders made by their on-line customers in a timely fashion.

The fulfillment problems of some “dot com” companies got so bad that the Federal Trade Commission was forced to take action against several prominent on-line retailers for failing to fulfill orders made during the 1999 holiday season. One analyst recently noted that “fulfillment has been the Achilles' heel for online retailers.”

It wasn't supposed to turn out this way. With an ability to sell goods and services around the globe without incurring the expense associated with building and operating “brick and mortar” stores, the “dot com” companies were expected to take over a significant, profitable share of the retail and wholesale distribution industries they targeted. A closer examination of the business practices of the “dot com” companies reveals that one of the root causes of the current malaise of “dot com” companies stems from the gold rush mentality that permeated the early days of the industry. At that time industry executives and investors in “dot com” companies justified their cut rate prices and explained away their losses by focusing on the “lifetime value” of the customers they were theoretically acquiring.

Unfortunately, the simplistic formulas many “dot com” companies were using to estimate “lifetime customer values” gave them the impression that they were building value when in fact the only thing they were building was piles of cancelled checks. Building customer loyalty is a process that, depending on the product or service, can take many transactions and many years to achieve. Getting someone to try your product or service is only one of the several steps that have to occur before a customer can realistically be considered a loyal customer. Providing a consistent, high quality purchase experience is one of the key steps in transforming a first time customer into a loyal one. The failure of many “dot com” companies to develop the processes that would ensure their new customers received even a basic level of service is a clear indication that many of them did not understand how to gauge the effectiveness of their efforts to build a customer base.

Because loyal customers are at the core of almost every valuable customer base, the problems many “dot com” companies experienced in understanding and developing loyal customers explain a great deal about their financial problems. The widespread use of discounting to attract customers is another practice that is at the root of the well publicized financial problems of the “dot com” companies. Discounting may be an effective mechanism for attracting initial customers, however, in the absence of quality service, indiscriminant, across the board discounting will only satisfy the generally disloyal, price sensitive customers. A more refined approach to discounting would discount only those products that are in fact driving a desired customer make a purchase while charging full (or nearly full) price on the other items being purchased. This procedure could also be extended to minimize discounts to customers that are expected to provide a smaller lifetime value to the “dot com” company. Along these same lines, the impact of the discounts that are given to the customers can be further minimized by:

1. Taking full advantage of the variety of volume discounts that vendors provide, and

2. Using the discount purchase volume to strengthen the “dot com” companies relationship with its most valuable suppliers.

Even if the problems of order fulfillment and indiscriminant discounting were solved, the simplified models that “dot com” companies use for estimating “life-time customer value” would still cause financial problems in many cases. This oversight occurs because most “life-time customer value” calculations simply multiply average life time sales by the expected margin on the product or service being purchased. Problems with this method include:

1. The actual impact of the customer relationship on the financial performance of the enterprise isn't explicitly analyzed,

2. The interaction with other elements of value is ignored—if the value the company realizes from a customer's purchase is attributable at least in part to elements of value other than the “customer relationship”, then efforts to boost customer relationships by offering discounts may actually cause long term losses instead of long term gains, and

3. The expected life of the customer relationship is not analyzed systematically—the longevity and purchasing patterns of different types of customers can vary significantly.

The need for a systematic approach for managing the customer acquisition and retention process is just part of a larger need that has recently appeared for a new method for systematically evaluating and improving the financial performance of business processes.

Unfortunately, the traditional practice in for many business process managers is to ignore the medium and long-term ramifications of their decisions and focus only on investments that provide a payback within the current year. One reason for this short-term focus is that there are no tools to managers in analyzing the impact of uncertainty and long term price trends on their process management decisions. Another shortcoming of all known process management systems is that they fail to focus on the impact the process on the enterprise or multi-enterprise organization that owns the process. More specifically, all known process management systems also fail to address:

1. the five different ways in which business value can be created for an enterprise (providing products or services that generate cash, holding income producing financial assets, holding derivatives, creating real options for generating cash and market sentiment);

2. three different types of risk (element variability, external factor variability and event risk) for each of the 5 business value creation methods;

3. the inter-relationship between value and risk; and/or

4. the complex inter-relationships between process features and enterprise elements of value, segments of value, external factors and/or event risks.

The importance of analyzing these different factors will vary by process, enterprise and organization. However, in aggregate they can alter the economics of a process in such a way that the best set of process features when enterprise or organization value and risk are optimized will be different than the “optimal” set of features for the stand-alone process. The enterprises and organizations operating the process are, of course, interested in optimizing their own financial performance so the utility of process analysis applications that don't consider this perspective is questionable at best.

In light of the preceding discussion, it is clear that it would be desirable to have an automated system that optimized the expected risk and return to an enterprise or organization from processes it owned. Ideally, this system would be capable of optimizing a wide variety of processes.

### SUMMARY OF THE INVENTION

It is a general object of the present invention to provide a novel and useful system that calculates and displays the list of the process features that maximize expected value while minimizing risk for enterprise or multi-enterprise process owner that overcomes the limitations and drawbacks of the prior art that were described previously. The system of the present invention is the first known system with the ability to optimize process design from the enterprise or multi-enterprise organization perspective or frame (hereinafter, frame).

Before going further, we need to define the term's process, feature and owner. A process is an activity or a collection of activities that are initiated and completed on more than one occasion over an indefinite time period as required to produce one or more deliverables. The process deliverables can have expected lives that are limited to a fraction a second, indefinite or anything between these two extremes. Every process uses resources, produces one or more deliverables and has features. The resources used by a process can include: consumable resources (i.e. crude oil), intermittent resources (i.e. maintenance labor) and long term resources (i.e. the refinery process and equipment). In this specific example, the crude oil is an external factor, the maintenance labor can belong to either the employee element of value or a supplier element of value and the long term resources are equipment and process elements of value within the matrices of value and risk for the enterprise or multi-enterprise organization as detailed in cross-referenced application Ser. No. 09/994,720 filed Nov. 28, 2001 and application Ser. No. 09/994,739 filed Nov. 28, 2001. Generally, a process requires the use of one or more elements of value. However, the system of the present invention will optimize a process with only one element of value. When used to optimize the performance of one element of value for all the processes that utilize the element, the system of the present invention functions as an “asset management system”.

Features encapsulate all the different options the process manager has for using the resources required to produce the deliverable. For example, an oil refinery process consumes a crude oil. Saudi light crude and Venezuelan Heavy Crude are examples of features that could be used to satisfy this requirement. During the expected life of the process deliverable, the deliverable provides an output or outputs that are expected to benefit the process owner. For our purposes, the process owner will be the enterprise or multi-enterprise organization that is expected to receive a direct economic benefit from the deliverable output. An economic benefit will be defined as improving the value or reducing the risk associated with one or more cell within the matrix of value and/or the matrix of risk for the enterprise or multi-enterprise organization that owns the process. In some cases, the process owner may not be the enterprise or organization operating for the process. It should also be noted at this point that the system of the present invention can be used to optimize the process operation from other frames in addition to the frame (owner perspective) we will focus on.

Analyzing the process from the frame of the process owner requires mapping the process resources, features and deliverables to the matrix of value and the matrix of risk for the process owner before optimizing the process feature selection. The mapping actually occurs in two steps. The first step requires mapping the process resources, features and deliverables to cells within the matrix of value and/or the matrix of risk. The first mapping step can be completed by the user (20) or it can be completed in an automated fashion if the data from the process management system database (30) is tagged with xsd and/or xml information that identifies the cells where the process will have an impact. The second mapping step is generally completed in an automated fashion as the specific value drivers within each cell that would be impacted by the process are identified.

FIG. 7 illustrates how the deliverables from the price optimization process described in cross-referenced patent application Ser. No. 09/678,019 dated Oct. 4, 2000 could be mapped to the matrices of value and risk for the process owner. The price optimization process deliverables are a promotion or price for causal sku's. The new pricing would be expected to impact: sales from existing customers, customer relationship strength, supplier relationship strength, stock market perception (assumes customer and supplier relationship strength are causal to market sentiment) and event risk. Once the process outputs are mapped to the matrices of value and risk for the process owner, the process can be optimized from the frame of the process owner.

In accordance with the invention, the automated extraction, aggregation, analysis and optimization of owner and process feature data from a variety of existing computer-based systems significantly increases the scale and scope of the analyses that can be completed by users without a significant background in finance. To facilitate its use as a tool for improving the value of a process, the system of the present invention produces reports in formats that are graphical and highly intuitive. This capability gives engineers and designers the tools they need to dramatically improve the long-term financial performance of the process they develop and operate for the process owners.

### BRIEF DESCRIPTION OF DRAWINGS

These and other objects, features and advantages of the present invention will be more readily apparent from the following description of the preferred embodiment of the invention in which:

FIG. 1 is a block diagram showing the major processing steps of the present invention;

FIG. 2 is a diagram showing the files or tables in the application database of the present invention that are utilized for data storage and retrieval during the processing in the system for process risk and return management;

FIG. 3 is a block diagram of an implementation of the present invention;

FIG. 4 is a diagram showing the data windows that are used for receiving information from and transmitting information to the user (20) during system processing;

FIG. 5A and FIG. 5B are block diagrams showing the sequence of steps in the present invention used for extracting, aggregating and storing information utilized in system processing from: user input, the process management system database, optionally, the simulation program database; the Internet; and the Owner Value Map® System database;

FIG. 6A and FIG. 6B are block diagrams showing the sequence of steps in the present invention that are utilized in identifying the process features that maximizes expected process value while minimizing risk for the enterprise or multi-enterprise organization that owns the process;

FIG. 7 is a diagram illustrating how process deliverables, features and resources are mapped to the matrices of value and risk for the process owner;

FIG. 8 is a block diagram showing the sequence of steps in the present invention used for completing analyses, communicating process feature selection to other systems and displaying, selecting and printing management reports; and

FIG. 9 is a sample report showing the efficient frontier for Organization XYZ, the current position of XYZ relative to the efficient frontier and the forecast of the new position of XYZ relative to the efficient frontier after the process is optimized.

### DETAILED DESCRIPTION OF THE PREFERRED EMBODIMENT

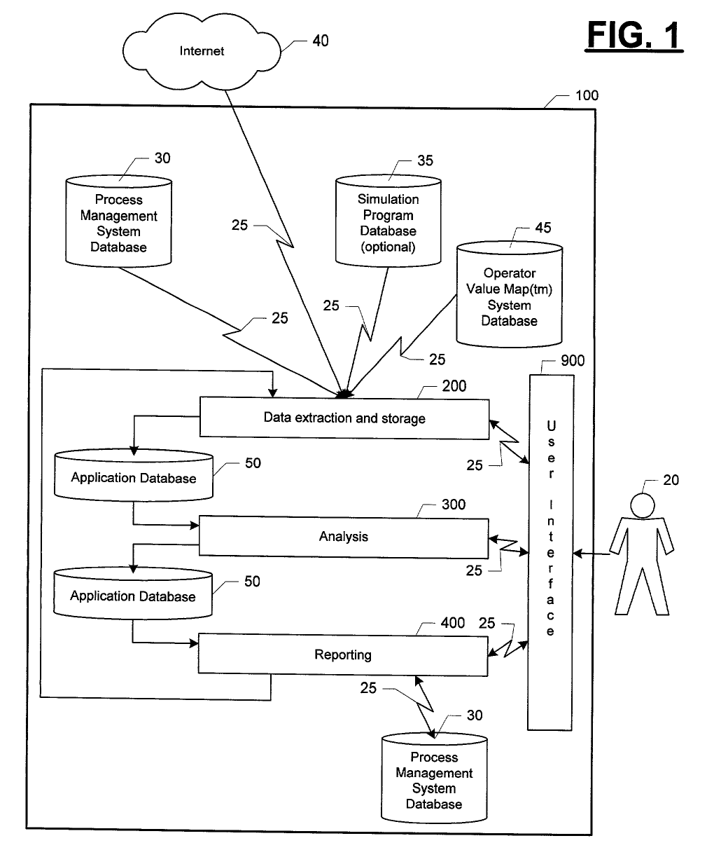

FIG. 1 provides an overview of the processing completed by the innovative system for process management. In accordance with the present invention, an automated method of and system (100) for optimizing risk and return from a process is provided. Processing starts in this system (100) with a block of software (200) that extracts, aggregates and stores the data and user input required for completing the analysis. This information is extracted via a network (25) from a process management system database (30), optionally, a simulation program database (35), the Internet (40) and an Owner Value Map® System database (45). These information extractions and aggregations are guided by a user (20) through interaction with a user-interface portion of the application software (900) that mediates the display and transmission of all information to the user (20) from the system (100) as well as the receipt of information into the system (100) from the user (20) using a variety of data windows tailored to the specific information being requested or displayed in a manner that is well known. While only one database of each type (30, 35 & 45) is shown in FIG. 1, it is to be understood that the system (100) can extract data from multiple databases of each type via the network (25).

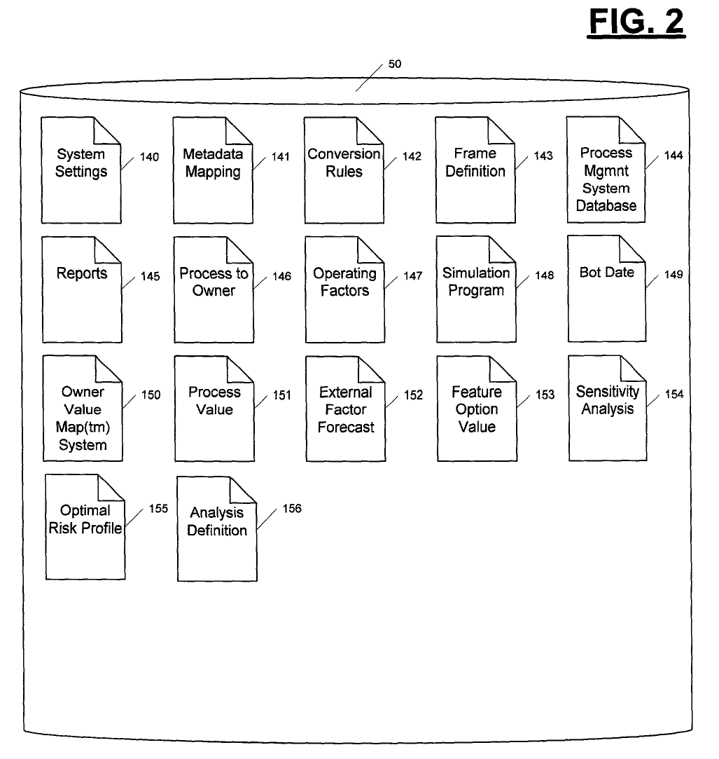

All extracted information concerning the process is stored in a file or table (hereinafter, table) within an application database (50) as shown in FIG. 2. The application database (50) contains tables for storing user input, extracted information and system calculations including a system settings table (140), a metadata mapping table (141), a conversion rules table (142), a frame definition table (143), a process management system database table (144), a reports table (145), a process to owner table (146), an operating factors table (147), a simulation program table (148), a bot date table (149), an Owner Value Map® System table (150), a process value table (151), a external factor forecast table (152), a feature option value table (153), a sensitivity analysis table (154), an optimal risk profile table (155) and an analysis definition table (156). The application database (50) can optionally exist as a datamart, data warehouse, departmental warehouse or storage area network. The system of the present invention has the ability to accept and store supplemental or primary data directly from user input, a data warehouse or other electronic files in addition to receiving data from the databases described previously. The system of the present invention also has the ability to complete the necessary calculations without receiving data from one or more of the specified databases. However, in the preferred embodiment all required information is obtained from the specified databases (30, 35 & 45) and the Internet (40).

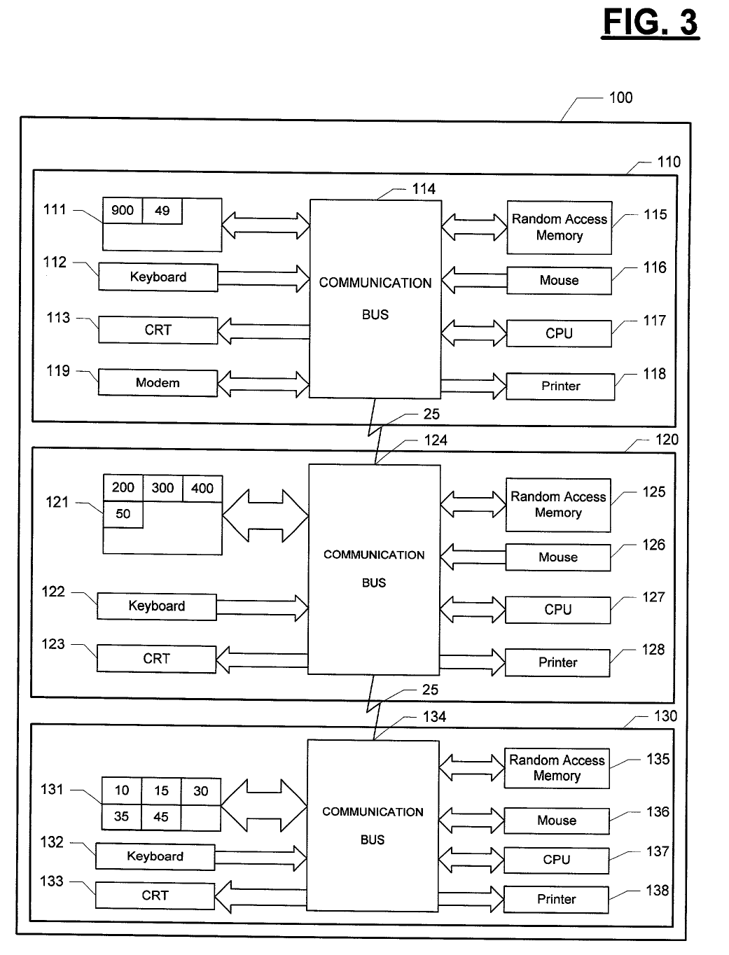

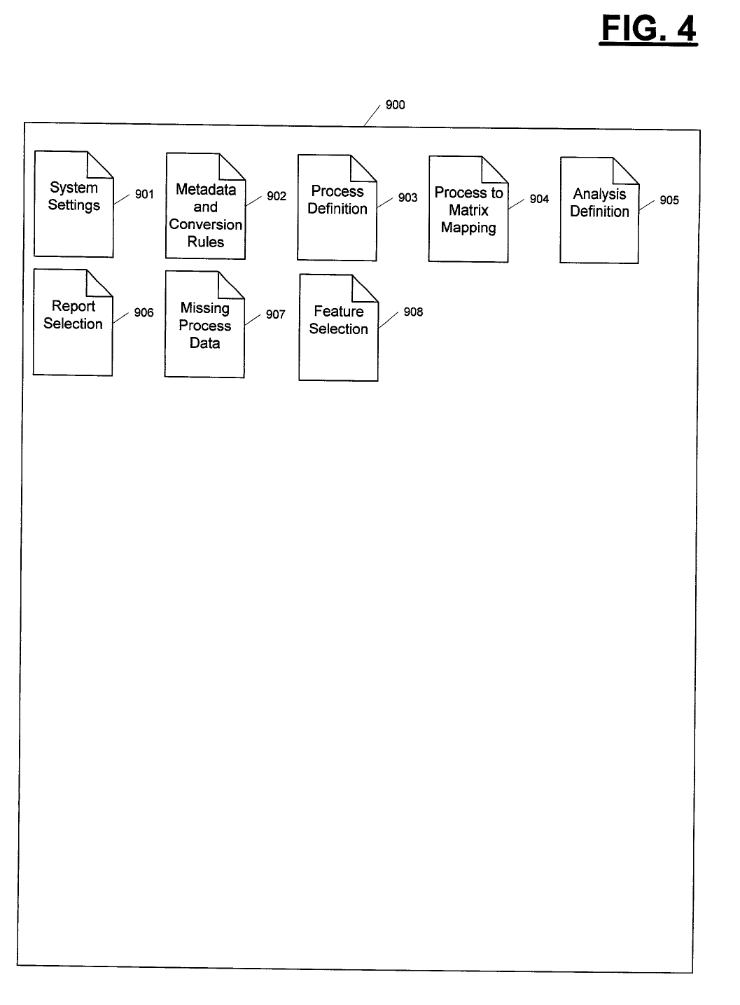

As shown in FIG. 3, the preferred embodiment of the present invention is a computer system (100) illustratively comprised of a client personal computer (110) connected to an application server personal computer (120) via a network (25). The application server personal computer (120) is in turn connected via the network (25) to a database-server personal computer (130).

The database-server personal computer (130) has, a hard drive (131) for storage of the design system database (10), operating factors database (15), process management system database (30), optionally, the simulation program database (35), and the Owner Value Map® System database (45), a keyboard (132), a CRT display (133), a communications bus (134) and a read/write random access memory (135), a mouse (136), a CPU (137), and a printer (138).

The application-server personal computer (120) has a hard drive (121) for storage of the application database (50) and the majority of the application software (200, 300 and 400) of the present invention, a keyboard (122), a CRT display (123), a communications bus (124), and a read/write random access memory (125), a mouse (126), a CPU (127), and a printer (128). While only one client personal computer is shown in FIG. 3, it is to be understood that the application-server personal computer (120) can be networked to fifty or more client personal computers (110) via the network (25). The application-server personal computer (120) can also be networked to fifty or more server, personal computers (130) via the network (25). It is to be understood that the diagram of FIG. 3 is merely illustrative of one embodiment of the present invention.

The client personal computer (110) has a hard drive (111) for storage of a client data-base (49) and the user-interface portion of the application software (900), a keyboard (112), a CRT display (113), a communication bus (114), a read/write random access memory (115), a mouse (116), a CPU (117), a printer (118) and a modem (119).

The application software (200, 300 and 400) controls the performance of the central processing unit (127) as it completes the calculations required for process risk and return management. In the embodiment illustrated herein, the application software program (200, 300 and 400) is written in Java. The application software (200, 300 and 400) also uses Structured Query Language (SQL) for extracting data from other databases (30, 35 and 45) and then storing the data in the application database (50) or for receiving input from the user (20) and storing it in the client database (49). The other databases contain process management system data (30), process simulations (35) and the elements of value, external factors and event risks of the commercial enterprise that owns the process (45). The user (20) provides the information to the application software as required to determine which data need to be extracted and transferred from the database-server hard drive (131) via the network (25) to the application-server computer hard drive (121) by interacting with user-interface portion of the application software (900). The extracted information is combined with input received from the keyboard (113) or mouse (116) in response to prompts from the user-interface portion of the application software (900) before processing is completed.

User input is initially saved to the client database (49) before being transmitted to the communication bus (125) and on to the hard drive (122) of the application-server computer via the network (25). Following the program instructions of the application software, the central processing unit (127) accesses the extracted data and user input by retrieving it from the hard drive (122) using the random access memory (121) as computation workspace in a manner that is well known.

The computers (110, 120 and 130) shown in FIG. 3 illustratively are personal computers or any of the more powerful computers or workstations that are widely available. Typical memory configurations for client personal computers (110) used with the present invention should include at least 128 megabytes of semiconductor random access memory (115) and at least a 2-gigabyte hard drive (111). Typical memory configurations for the application-server personal computer (120) used with the present invention should include at least 256 megabytes of semiconductor random access memory (125) and at least a 250 gigabyte hard drive (121). Typical memory configurations for the database-server personal computer (130) used with the present invention should include at least 1024 megabytes of semiconductor random access memory (135) and at least a 500 gigabyte hard drive (131).

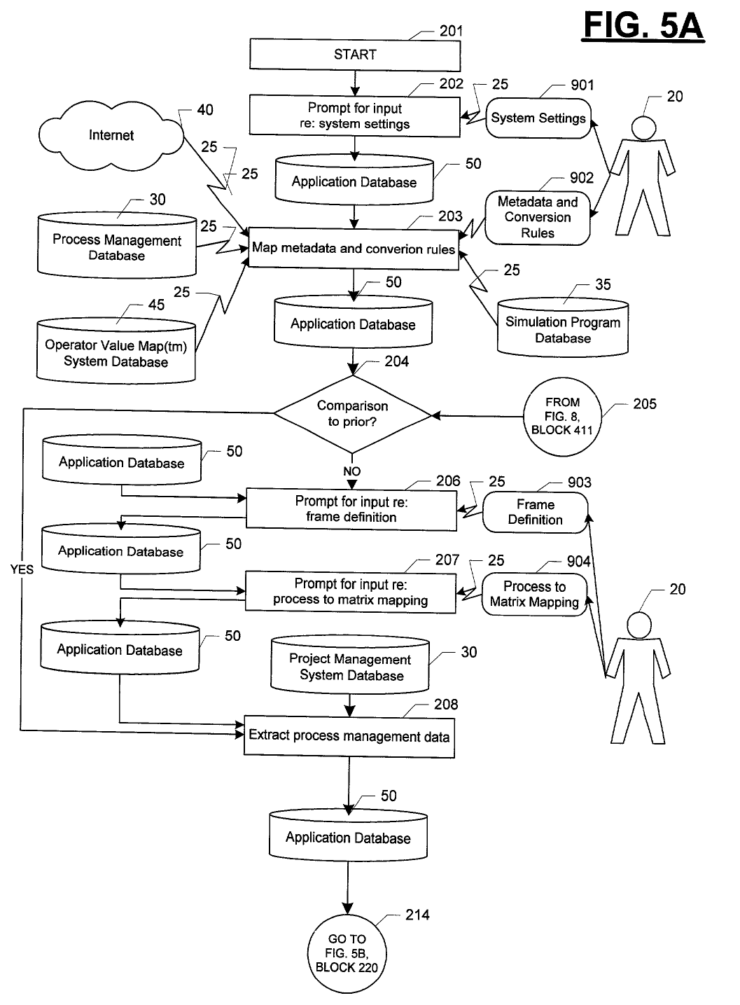

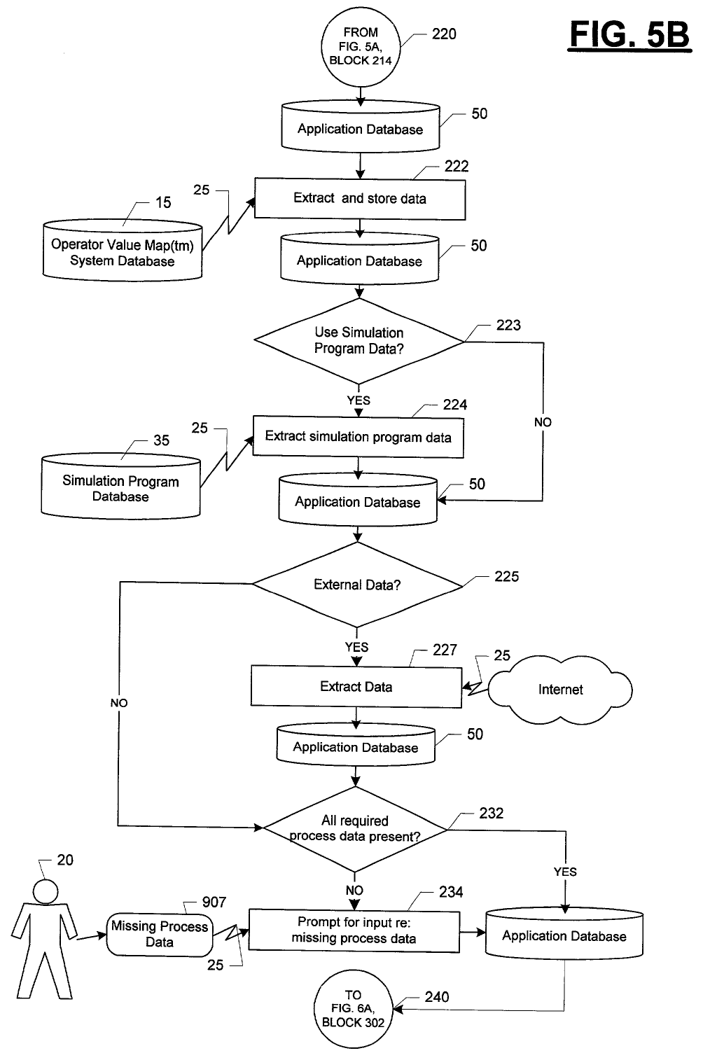

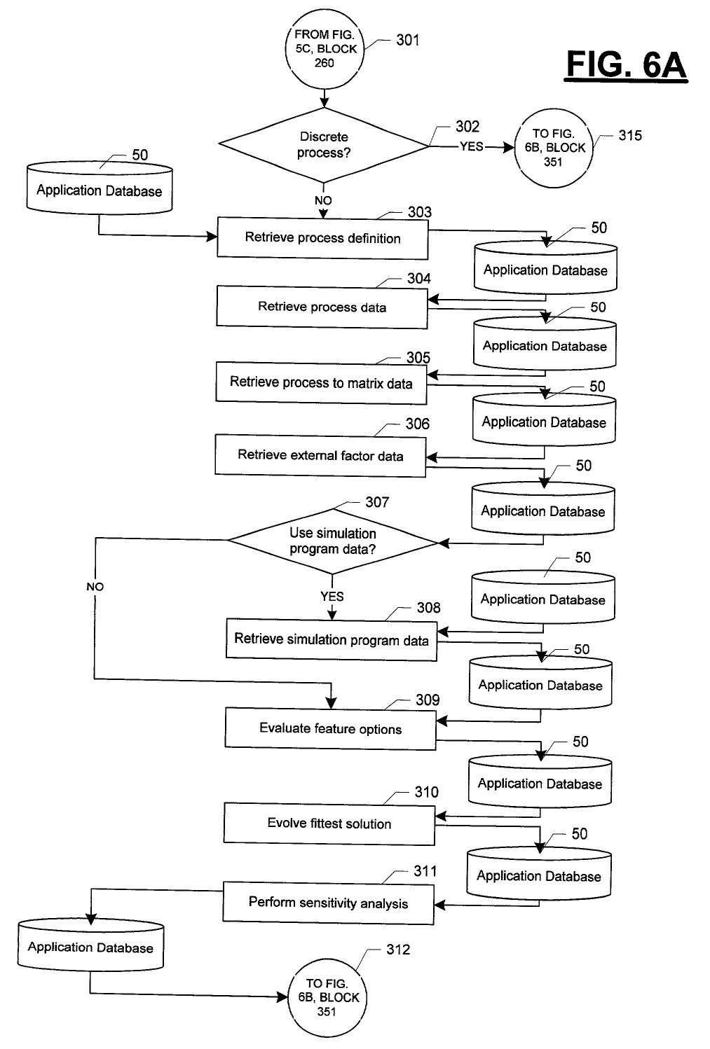

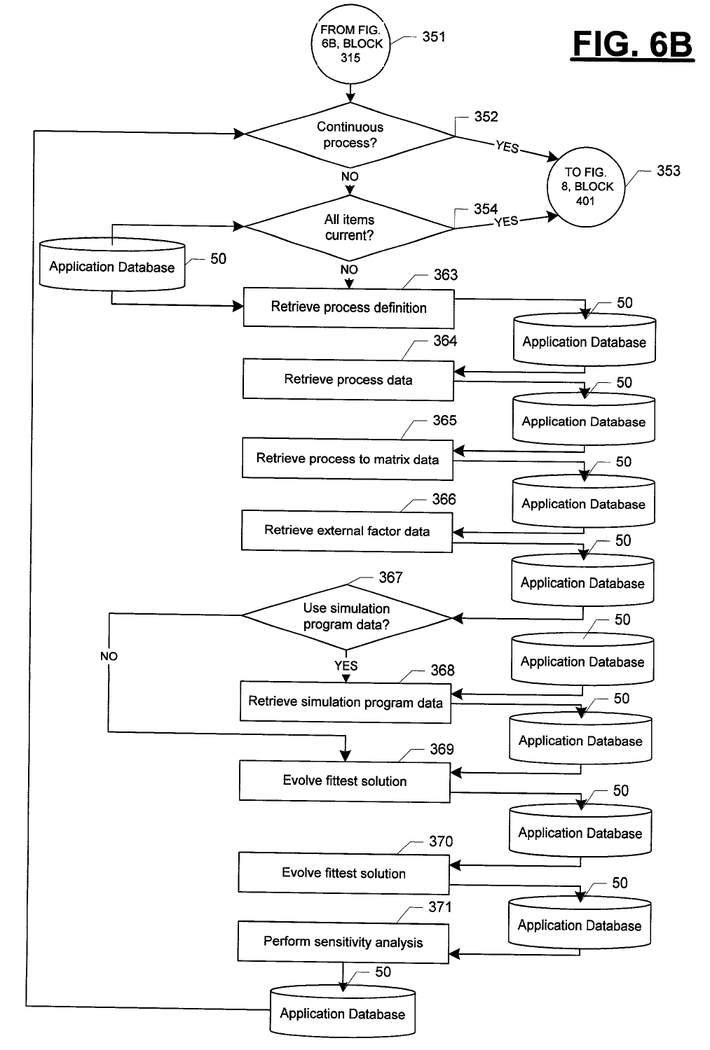

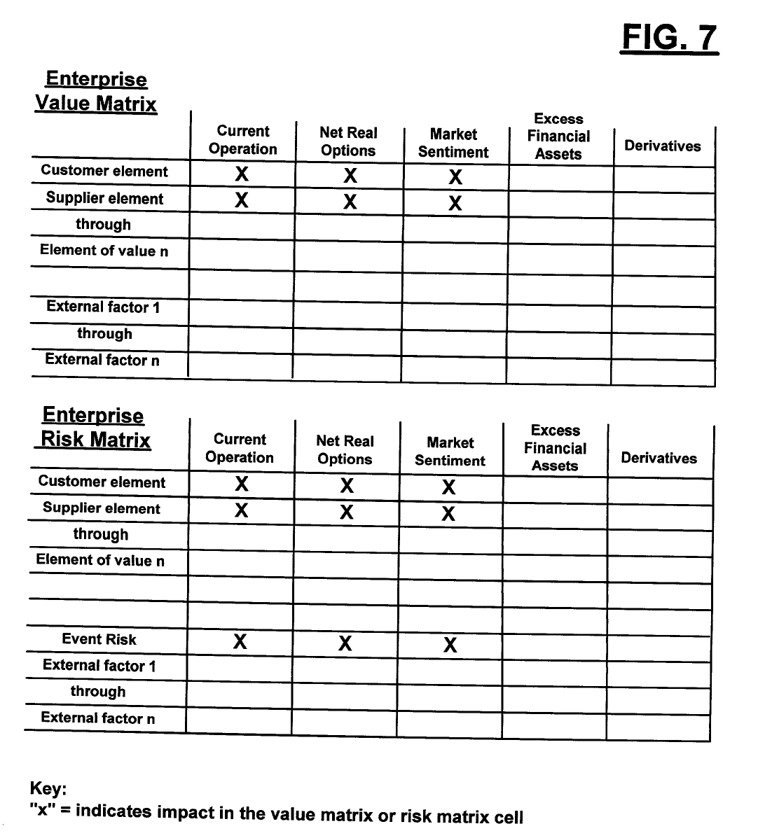

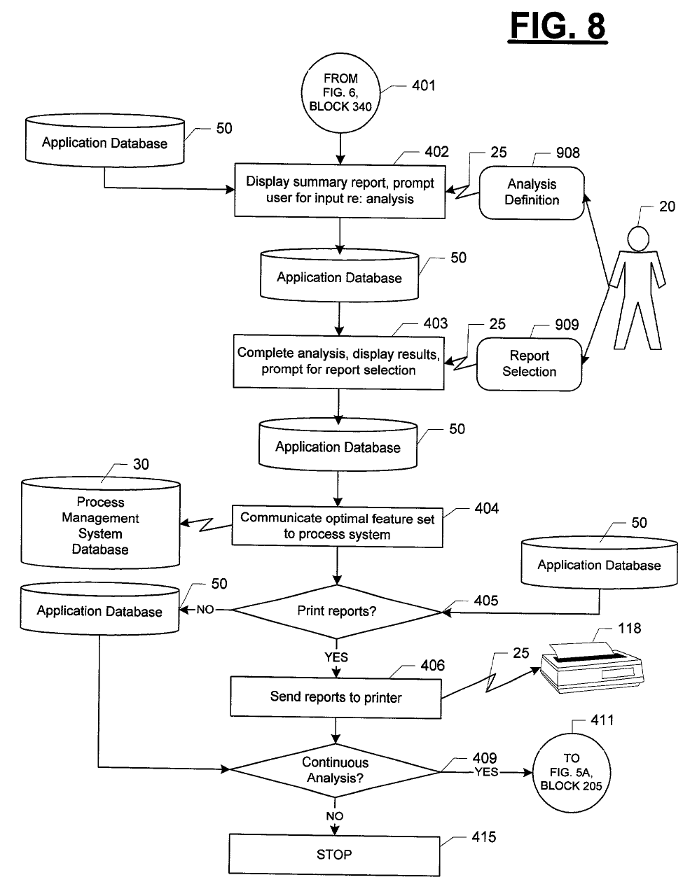

Using the system described above, the risk and return of the process being analyzed will be optimized from the perspective of the process owner. Optimizing the risk and return of a process as outlined previously is completed in three distinct stages. The first stage of processing (block 200 from FIG. 1) extracts, aggregates and stores the data from user input, internal databases (30, 35 or 45) and the internet (40) as shown in FIG. 5A and FIG. 5B. The second stage of processing (block 300 from FIG. 1) analyzes the extracted data and determines the mix of process features and feature options that maximizes process value while minimizing process risk as shown in FIG. 6. The third and final stage of processing (block 400 from FIG. 1) displays the results of the prior calculations, completes special analyses, communicates with other systems and displays detailed graphical reports and optionally prints them as shown in FIG. 8.

### DATA EXTRACTION AND STORAGE

The flow diagrams in FIG. 5A and FIG. 5B detail the processing that is completed by the portion of the application software (200) that extracts, aggregates and stores the information required for system operation from: a process management system database (30), optionally, a simulation program database (35), the Internet (40) and an Owner Value Map® System database (45) and the user (20). A brief overview of the different databases will be presented before reviewing each step of processing completed by this portion (200) of the application software.

The systems used for process management can be divided into two categories, continuous process management systems and discrete process management systems. As the name implies, continuous process management systems are used to monitor and manage processes that are continuously operating as required to process materials, data, and other resources. Continuous processes are found in: chemical refineries, petroleum refineries, information technology systems, large networks like the phone system and the Internet. The management and optimization of these processes involves changing the features and/or resources that are currently being used to a new set that will improve performance. Discrete processes are processes that respond to individual or group requirements for process outputs. For example, the cross-referenced application Ser. No. 09/678,019 discloses a systematic process for using customer, supplier and company data to develop pricing and promotional offers. In either case, the process management system database (30) will generally include: information concerning the historical performance of the process including the features used to achieve the different performance levels and the forecast demand for the process.

Because most processes involve the use of more than one element of value, it is possible that the data related to the process may be stored in more the one database. For example, the interactive sales process described in cross-referenced application Ser. No. 09/679,109 filed Oct. 4, 2000 would be expected to draw customer data from a customer relationship management system, supplier data from a supply chain management system and web site data from a web site transaction log. The system of the present invention is capable of processing the process related data if it resides in more than one database. The extraction, conversion and storage of the distributed data could be guided by the user (20) during system setting or the system of the present invention could identify the required systems and data in an automated fashion if the proper xsd and xml tagging is in place.

Simulation programs such as MatLab, Simulink, SPICE, etc. can optionally be used to generate performance data for forecast changes in process operation by calculating overall external factor consumption for the process and/or by forecasting process performance using a new set of resources and/or features. The information regarding process design and operating performance is combined with external factor price information downloaded from web sites and/or databases on the internet (40) as required to support risk and return management for the process being analyzed. The information on external factor prices will include both current prices and future prices.

The Owner Value Map™ System database (45) for an enterprise contains the matrix of value, matrix of risk and statistics generated by the system described in the cross referenced application Ser. No. 09/994,720 dated Nov. 28, 2001 and for a multi-enterprise organization it is the matrix of value, matrix of risk and statistics generated by the system detailed in cross-referenced application Ser. No. 09/994,739 dated Nov. 28, 2001.

System processing of the information from the different databases (30, 35 and 45) and the Internet (40) described above starts in a block 201, FIG. 5A, which immediately passes processing to a software block 202. The software in block 202 prompts the user (20) via the system settings data window (901) to provide system settings information. The system settings information entered by the user (20) is transmitted via the network (45) back to the application server (120) where it is stored in the system settings table (140) in the application database (50) in a manner that is well known. The specific inputs the user (20) is asked to provide at this point in processing are shown in Table 1.

```
TABLE 1
  1. Process owner
  2. Mode of operation (continuous or batch)
  3. Metadata standard
  4. Process resource and feature map
  5. Location of process management system database and metadata
    (optional)
  6. Location of simulation system databases and metadata (optional)
  7. Location of external database and metadata (optional)
  8. Location of Owner Value Map ® System database and metadata
    (optional)
  9. Scenario (combined normal, extreme is default)
10. Location of account structure
11. Base currency
12. Risk free cost of capital
13. Risk adjusted cost of capital
14. Management report types (text, graphic, both)
15. Default reports
16. Default missing data procedure
17. Maximum time to wait for user input
18. Maximum number of generations to process without improving fitness
```

The specification of the location and metadata information for the process management system database, simulation database, external database and Owner Value Map®) System database are optional because that information may have been included in the xsd and/or xml information attached to each system and data element. In which case, the software in this block would be able to locate the required data without the user (20) having to specify its metadata standard and location. After the storage of system settings data is complete, processing advances to a software block 203.

The software in block 203 prompts the user (20) via the metadata and conversion rules window (902) to map all relevant metadata using the standard specified by the user (20) from the process management system database (30), optionally, a simulation program database (35), the Internet (40) and an Owner Value Map® System database (45) to the process resource and feature map stored in the system settings table (140). The metadata mapping specifications are saved in the metadata mapping table (141).

As part of the metadata mapping process, any database fields that are not mapped to the process resource and feature map are defined by the user (20) as non-relevant attributes. This information is also saved in the metadata mapping table (141). After all fields have been mapped to the metadata mapping table (141), the software in block 203 prompts the user (20) via the metadata and conversion rules window (902) to provide conversion rules for each metadata field for each data source. Conversion rules will include information regarding currency conversions and conversion for units of measure that may be required to consistently analyze the data. The inputs from the user (20) regarding conversion rules are stored in the conversion rules table (142) in the application database (50). After conversion rules have been stored for all fields from every data source, then processing advances to a software block 204.

The software in block 204 checks the system settings table (140) in the application database (50) to determine if the current calculation is a new calculation or a comparison to a prior calculation. If the calculation is a comparison to a prior calculation, then processing advances to a software block 208. Alternatively, if the calculation is not a comparison to a prior calculation, then processing advances to a software block 206.

The software in block 206 prompts the user (20) via the frame definition window (903) to define frames for analysis. It is worth noting here that there are generally at least two frames—the process owner frame and the stand-alone frame—for each process. The frame definition(s) include a brief description of the process, the frame time span and the definition of the entity being optimized. The specification of each frame is stored in the frame definition table (143) in the application database (50) before processing advances to a software block 207.

The software in block 207 prompts the user (20) via the process to matrix mapping window (904) to define the relationship between process outputs and the matrices of value and risk for the owner. The specification of each process is stored in the process to owner table (146) in the application database (50) before processing advances to a software block 208.

The software in block 208 checks the bot date table (149) and deactivates any process management system data bots with creation dates before the current system date and retrieves information from the system settings table (140), metadata mapping table (141), the conversion rules table (142) and the frame definition table (143). The software in block 208 then initializes data bots for each field in the metadata mapping table (141) that mapped to the process management system database (30). Bots are independent components of the application that have specific tasks to perform. In the case of data acquisition bots, their tasks are to extract and convert data from a specified source and then store it in a specified location. Each data bot initialized by software block 208 will store its data in the process management system table (145). Every process management system data bot contains the information shown in Table 2.

```
TABLE 2
  1. Unique ID number (based on date, hour, minute, second of creation)
  2. The data source location
  3. Mapping information
  4. Timing of extraction
  5. Owner
  6. Process
  7. Frame
  8. Conversion rules (if any)
  9. Storage location (to allow for tracking of source and destination
    events)
10. Creation date (date, hour, minute, second)
```

After the software in block 208 initializes the bots for every mapped field within the process management system database (30) by frame, the bots extract and convert data in accordance with their preprogrammed instructions. After the extracted and converted data is stored in the process management system database table (144), processing advances to a software block 222.

The software in block 222 checks the bot date table (149) and deactivates any Owner Value Map® System data bots with creation dates before the current system date and retrieves information from the system settings table (140), metadata mapping table (141), the conversion rules table (142) and the frame definition table (143). The software in block 222 then initializes data bots for retrieving the entire matrix of value and risk for each owner as well as detailed information for each cell identified the process to owner table (146) that mapped to a process feature or resource. Bots are independent components of the application that have specific tasks to perform. In the case of Owner Value Map® System data bots, their tasks are to extract and convert data detailing the matrices of value and risk for the specified owner from a specified source and store the information in a specified location. Each data bot initialized by software block 222 will store its data in the Owner Value Map® Systems table (150). Every Owner Value Map® System data bot contains the information shown in Table 3.

```
TABLE 3
  1. Unique ID number (based on date, hour, minute, second of creation)
  2. The data source location
  3. Mapping information
  4. Timing of extraction
  5. Owner
  6. Process
  7. Frame
  8. Segment of value, element of value, external factor or event risk
  9. Conversion rules (if any)
10. Storage location (to allow for tracking of source and destination
    events)
11. Creation date (date, hour, minute, second)
```

After the software in block 222 initializes the bots they extract and convert data in accordance with their preprogrammed instructions by frame. After the extracted and converted data is stored in the Owner Value Map® Systems table (150) by frame, processing advances to a software block 223.

The software in block 223 checks the system settings table (140) to determine if simulation program data is being used in the process analysis. If simulation program data are being used, then processing advances to a software block 224. Alternatively, if simulation program data are not being used, then processing advances to a software block 225.

The software in block 224 checks the bot date table (149) and deactivates any simulation program data bots with creation dates before the current system date and retrieves information from the system settings table (140), metadata mapping table (141), the conversion rules table (142) and the frame definition table (143). The software in block 224 then initializes data bots by frame for each field in the process feature and resource map (141) that mapped to a field in the simulation programs database (35). Bots are independent components of the application that have specific tasks to perform. In the case of data bots, their tasks are to extract and convert data from a specified source and then store it in a specified location. Each data bot initialized by software block 224 will store its data in the simulation programs table (148). Every simulation program data bot contains the information shown in Table 4.

```
TABLE 4
  1. Unique ID number (based on date, hour, minute, second of creation)
  2. The data source location
  3. Mapping information
  4. Timing of extraction
  5. Owner
  6. Process
  7. Frame
  8. Simulation result
  9. Conversion rules (if any)
10. Storage location (to allow for tracking of source and destination
    events)
11. Creation date (date, hour, minute, second)
```

After the software in block 224 initializes the bots for every mapped result within the simulation programs database (35) by frame, the bots extract and convert data in accordance with their preprogrammed instructions. After the extracted and converted data is stored in the simulation program table (148), processing advances to a software block 225.

The software in block 225 checks the system settings table (140) to determine if any data from external databases is being used in the process analysis. If data from external databases are being used, then processing advances to a software block 227. Alternatively, if simulation program data are not being used, then processing advances to a software block 232.

The software in block 227 checks the bot date table (149) and deactivates any external factor price data bots with creation dates before the current system date and retrieves information from the system settings table (140), metadata mapping table (141), the conversion rules table (142) and the frame definition table (143). The software in block 227 then initializes data bots by external factor for each field in the metadata mapping table (141) that mapped to an external factor price on the Internet (40). Bots are independent components of the application that have specific tasks to perform. In the case of data bots, their tasks are to extract and convert data from a specified source for the time period and then store it in a specified location. Each data bot initialized by software block 227 will store the data it retrieves in the external factor price table (150). Every external factor price data bot contains the information shown in Table 5.

```
TABLE 5
  1. Unique ID number (based on date, hour, minute, second of creation)
  2. The data source location
  3. Mapping information
  4. Timing of extraction
  5. Owner
  6. Process
  7. Frame
  8. External factor
  9. Time period(s)
10. Conversion rules (if any)
11. Storage location (to allow for tracking of source and destination
    events)
12. Creation date (date, hour, minute, second)
```

After the software in block 227 initializes the bots for every mapped external factor on the Internet (40), the bots extract and convert data in accordance with their pre-programmed instructions. After the extracted and converted data is stored in the external factor forecast table (150), processing advances to a software block 232.

The software in block 232 compares the data in the process management system database table (144), the simulation program table (148), the Owner Value Map® System Table (150) and the external factor forecast table (152) to determine if there any periods where required data is missing for any process. If data is missing for any process, then processing advances to a software block 234. Alternatively, if the required data is present for every process for every time period, then processing advances to a software block 302.

The software in block 234 prompts the user (20) via the missing process data window (907) to input the missing data displayed on the window. The new information supplied by the user (20) is stored in the appropriate table before processing advances to software block 302.

### ANALYSIS

The flow diagrams in FIG. 6A and FIG. 6B detail the processing that is completed by the portion of the application software (300) that determines the mix of process features and options that maximize value while minimizing risk for the process owner and for other specified frames. This potion of the application software (300) also evaluates the sensitivity of the optimal solution to changing external factor and/or feature prices. The data being analyzed is generally normalized before processing begins.

Processing in this portion of the application begins in software block 302. The software in block 302 checks the system settings table (140) in the application database (50) to determine if the current calculation is for discrete process optimization or continuous process optimization. If the process that is being optimized is a discrete process, then processing advances to a software block 352. Alternatively, if the process (or processes) that are being optimized is a continuous process, then processing advances to a software block 303.

The software in block 303 retrieves data from the frame definition table (143), the process management system database table (144) and the process value table (151) as required to identify the process or processes that do not have current optimal mix configurations. After the software in the block identifies one or more processes without a current calculation for all frames, the software in block retrieves the complete definition of that process and the frames that are associated with it from the frame definition table (143), the process management system database table (144) before processing advances to a software block 304.

The software in block 304 retrieves the process data for the process being analyzed from the process management system database table (144) and the Owner Value Map® System table (150) before processing advances to a software block 305. The software in block 305 retrieves the process to owner mapping information for each process being analyzed from the process to owner table (146) and identifies the specific value drivers that are linked to process resource, feature and deliverables before processing advances to a software block 306. The software in block 306 retrieves the external factor prices for the process being analyzed from the external factor forecast table (152) before processing advances to a software block 307.

The software in block 307 checks the system settings table (140) to determine if simulation program data is being used in the process analysis. If simulation program data is being used, then processing advances to a software block 308. Alternatively, if simulation program data is not being used, then processing advances to a software block 309. The software in block 308 retrieves the feature, resource and deliverable data for the process being analyzed from the simulation program table (148) before processing advances to software block 309.

The software in block 309 checks the bot date table (149) and deactivates any feature option bots with creation dates before the current system date and retrieves information from the system settings table (140), metadata mapping table (141), the conversion rules table (142), the frame definition table (143), the process management system database table (144), the process to owner table (146), the operating factors table (147) and the simulation program table (148) if data from the latter table is being used. The software in block 309 then initializes feature option bots by feature for the process being analyzed by frame. Feature option bots calculate the value the option to add a feature or remove a baseline feature by process and frame. For example, the value of the option to add piping that would facilitate a retrofit to an alternate source of water supply at a later date could be valued. The value of the real option to add or remove each feature is calculated using Black Scholes algorithms and the baseline discount rate in a manner that is well known. The real option can be valued using other algorithms including binomial, Quadranomial, neural network or dynamic programming algorithms. Feature option bots contain the information shown in Table 6.

TABLE 6
1. Unique ID number (based on date, hour, minute, second of creation)
2. Creation date (date, hour, minute, second)
3. Mapping information
4. Storage location
5. Owner
6. Process
7. Process Feature
8. Frame
9. Baseline feature? (Y or N)

After the feature option bots are initialized, the bots activate in accordance with their preprogrammed instructions. After being activated, the bots complete the calculation of feature option values and save the resulting values in the feature option value table (153) in the application database (50) before processing advances to a software block 310.

The software in block 310 checks the bot date table (149) and deactivates any optimization bots with creation dates before the current system date and uses the previously retrieved information (from the system settings table (140), metadata mapping table (141), the conversion rules table (142), the frame definition table (143), the process management system database table (144), the process to owner table (146), the operating factors table (147), the simulation program table (148)— if data from there is being used—and the Owner Value Map® System table (150)). Bots are independent components of the application that have specific tasks to perform. In the case of optimization bots, their primary task is to determine the optimal mix of features and feature options for each process on a stand-alone basis by frame. The optimal mix is the mix that maximizes value and minimizes risk for the frame being analyzed. A bot for global optimization of all processes is also initiated. The optimization bots run simulations of process performance, owner risk and owner value using an unconstrained genetic algorithm that evolves to the most valuable scenario. Other optimization algorithms, including those with constraints can be used to the same effect. However, in the preferred embodiment genetic algorithms are used. Every optimization bot activated in this block contains the information shown in Table 7.

TABLE 7
1. Unique ID number (based on date, hour, minute, second of creation)
2. Creation date (date, hour, minute, second)
3. Mapping information
4. Storage location
5. Owner
6. Type: process or all processes
7. Process
8. Frame

After the optimization bots are initialized, the bots activate in accordance with their preprogrammed instructions. After being activated, the bots determine the mix of features and feature options that optimize the process for each frame. The optimal mix is saved in the process value table (151) in the application database (50) by frame before processing advances to a software block 311.

The software in block 311 checks the bot date table (149) and deactivates any sensitivity bots with creation dates before the current system date. The software in the block then uses the information that was previously retrieved (from the system settings table (140), metadata mapping table (141), the conversion rules table (142), the frame definition table (143), the process management system database table (144), the process to owner table (146), the operating factors table (147), the simulation program table (148)—if data from there is being used—and the Owner Value Map® System table (150)) as required to initialize the sensitivity bots. Bots are independent components of the application that have specific tasks to perform. In the case of sensitivity bots, their primary task is to determine the sensitivity of the optimal mix to changes in element availability, external factor price, deliverable price, feature price and feature option price by process and frame. The sensitivity bots run simulations of process performance, process value and process risk using an unconstrained genetic algorithm that evolves to the most valuable scenario. Every sensitivity bot activated in this block contains the information shown in Table 8.

```
TABLE 8
  1. Unique ID number (based on date, hour, minute, second of creation)
  2. Creation date (date, hour, minute, second)
  3. Mapping information
  4. Storage location
  5. Factor: external factor, operating factor, feature or feature option
  6. Owner
  7. Type: process or all processes
  8. Process
  9. Frame
10. Variable: feature, feature option, external factor, resource or
    deliverable
```

After the sensitivity bots are initialized, the bots activate in accordance with their preprogrammed instructions. After being activated, the bots determine how sensitive process value and the optimal mix of features and feature options are to changes in the process variables. The results of this analysis are saved in the sensitivity analysis table (154) in the application database (50) by process frame before processing advances to a software block 352.

The software in block 352 checks the system settings table (140) in the application database (50) to determine if the current calculation is for discrete process optimization or continuous process optimization. If the process that is being optimized is a discrete process, then processing advances to a software block 354. Alternatively, if the process (or processes) that is being optimized is a continuous process, then processing advances to a software block 402.

The software in block 354 checks the system settings table (140) in the application database (50) to determine if there are current calculations for all discrete process optimization items. If there are current calculations for all discrete process items, then processing advances to a software block 402. Alternatively, if there is an item (or items) that do not have current calculations, then processing advances to a software block 363.

The software in block 363 retrieves data from the frame definition table (143), the process management system database table (144) and the process value table (151) as required to identify the item or items that do not have current calculations. After the software in the block identifies one or more processes without a current calculation for all frames, the software in block retrieves the complete definition of that item, the process and the frames that are associated with it from the frame definition table (143), the process management system database table (144) before processing advances to a software block 364.

The software in block 364 retrieves the process data for the item being analyzed from the process management system database table (144) and the Owner Value Map® System table (150) before processing advances to a software block 365. The software in block 365 retrieves the process to owner mapping information for each process being analyzed from the process to owner table (146) and identifies the specific value drivers that are linked to process resource, feature and deliverables before processing advances to a software block 366. The software in block 366 retrieves the external factor prices for the item and process being analyzed from the external factor forecast table (152) before processing advances to a software block 367.

The software in block 367 checks the system settings table (140) to determine if simulation program data is being used in the process analysis. If simulation program data is being used, then processing advances to a software block 368. Alternatively, if simulation program data is not being used, then processing advances to a software block 369. The software in block 368 retrieves the feature, resource and deliverable data for the process and item being analyzed from the simulation program table (148) before processing advances to software block 369.

The software in block 369 checks the bot date table (149) and deactivates any feature option bots with creation dates before the current system date and retrieves information from the system settings table (140), metadata mapping table (141), the conversion rules table (142), the frame definition table (143), the process management system database table (144), the process to owner table (146), the operating factors table (147) and the simulation program table (148) if data from the latter table is being used. The software in block 369 then initializes feature option bots by feature for the item being analyzed by process and frame. Feature option bots calculate the value the option to add a feature or remove a baseline feature by process and frame for each item. For example, the value of the option to add piping that would facilitate a retrofit to an alternate source of water supply at a later date could be valued. The value of the real option to add or remove each feature is calculated using Black Scholes algorithms and the baseline discount rate in a manner that is well known. The real option can be valued using other algorithms including binomial, Quadranomial, neural network or dynamic programming algorithms. Feature option bots contain the information shown in Table 9.

```
TABLE 9
  1. Unique ID number (based on date, hour, minute, second of creation)
  2. Creation date (date, hour, minute, second)
  3. Mapping information
  4. Storage location
  5. Owner
  6. Process
  7. Process Feature
  8. Frame
  9. Baseline feature? (Y or N)
10. Item
```

After the feature option bots are initialized, the bots activate in accordance with their preprogrammed instructions. After being activated, the bots complete the calculation of feature option values and save the resulting values in the feature option value table (153) in the application database (50) by item before processing advances to a software block 370.

The software in block 370 checks the bot date table (149) and deactivates any optimization bots with creation dates before the current system date and uses the previously retrieved information (from the system settings table (140), metadata mapping table (141), the conversion rules table (142), the frame definition table (143), the process management system database table (144), the process to owner table (146), the operating factors table (147), the simulation program table (148)— if data from there is being used—and the Owner Value Map® System table (150)). Bots are independent components of the application that have specific tasks to perform. In the case of optimization bots, their primary task is to determine the optimal mix of features and feature options for each process on a stand-alone basis by frame. The optimal mix is the mix that maximizes value and minimizes risk for the item and frame being analyzed. The optimization bots run simulations of process performance and owner value using an unconstrained genetic algorithm that evolves to the most valuable scenario. Other optimization algorithms, including those with constraints can be used to the same effect. However, in the preferred embodiment genetic algorithms are used. Every optimization bot activated in this block contains the information shown in Table 10.

TABLE 10
1. Unique ID number (based on date, hour, minute, second of creation)
2. Creation date (date, hour, minute, second)
3. Mapping information
4. Storage location
5. Owner
6. Type: process or all processes
7. Process
8. Frame
9. Item

After the optimization bots are initialized, the bots activate in accordance with their preprogrammed instructions. After being activated, the bots determine the mix of features and feature options that optimize the process for each frame. The optimal mix is saved in the process value table (151) in the application database (50) by frame and item before processing advances to a software block 371.

The software in block 371 checks the bot date table (149) and deactivates any sensitivity bots with creation dates before the current system date. The software in the block then uses the information that was previously retrieved (from the system settings table (140), metadata mapping table (141), the conversion rules table (142), the frame definition table (143), the process management system database table (144), the process to owner table (146), the operating factors table (147), the simulation program table (148)—if data from there is being used—and the Owner Value Map® System table (150)) as required to initialize the sensitivity bots. Bots are independent components of the application that have specific tasks to perform. In the case of sensitivity bots, their primary task is to determine the sensitivity of the optimal mix to changes in element availability, external factor price, deliverable price, feature price and feature option price by process and frame. The sensitivity bots run simulations of process value and process risk using an unconstrained genetic algorithm that evolves to the most valuable scenario. Every sensitivity bot activated in this block contains the information shown in Table 11.

```
TABLE 11
  1. Unique ID number (based on date, hour, minute, second of creation)
  2. Creation date (date, hour, minute, second)
  3. Mapping information
  4. Storage location
  5. Factor: external factor, operating factor, feature or feature option
  6. Owner
  7. Type: process or all processes
  8. Process
  9. Frame
10. Variable: feature, feature option, external factor, resource or
    deliverable
```

After the sensitivity bots are initialized, the bots activate in accordance with their preprogrammed instructions. After being activated, the bots determine how sensitive process value and the optimal mix of features and feature options are to changes in the process variables. The results of this analysis are saved in the sensitivity analysis table (154) in the application database (50) by item and frame before processing advances to a software block 402.

### REPORTING

The flow diagram in FIG. 8 details the processing that is completed by the portion of the application software (400) that performs special analyses, communicates the optimal mix to the process management system and creates, displays and optionally prints process management reports.

Processing in this portion of the application begins in software block 402. The software in block 402 retrieves information from the process value table (151) as required to display the optimal mix of process features and feature options from the owners frame. The optimal mix for other frames can also be displayed at this time. The software in block 402 then prompts the user (20) via the analysis definition window (908) to optionally edit the optimal mix that was displayed and/or to suggest other changes in the optimal mix. Any input regarding a change to the optimal mix is saved in the analysis definition table (156) before processing advances to a software block 403. The users input regarding changes in the optimal mix could also be forwarded to a simulation program at this point to determine if the user (20) specified changes had any material affect on the external factor consumption by the process.

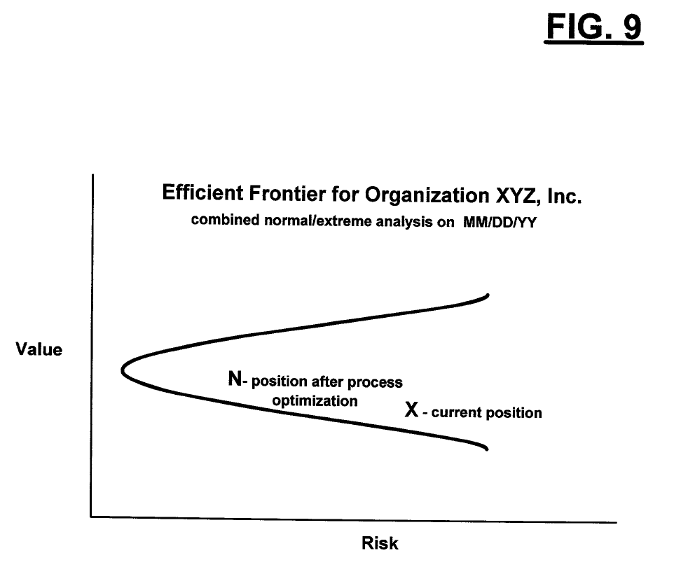

If the user (20) has specified changes to the optimal mix, then the software in block 403 completes an analysis of the impact of the changes from all relevant frames using the optimization process described previously for blocks 310 and 370. Other optimization algorithms can be used to the same effect. The software in block 403 also defines a probabilistic simulation model to analyze the proposed changes. The preferred embodiment of the probabilistic simulation model is a Markov Chain Monte Carlo model. However, other simulation models can be used with similar results. The model is defined using the information retrieved from the analysis definition table (156) and then iterated as required to ensure the convergence of the frequency distribution of the output variables. After the calculation has been completed, the software in block 403 saves the resulting information in the analysis definition table (156). After displaying the results of the optional change analysis using the report selection window (909), the user (20) is prompted to specify which set of features and feature options—the optimal mix or the mix defined by the user (20) should be passed on to process management system. The mix selected for transmission to the process management system is stored in the process value table (151). After data storage is complete, the software in block 403 prompts the user (20) via a report selection data window (909) to designate reports for creation, display and/or printing. One report the user (20) has the option of selecting at this point shows the value of each feature or feature option to the process and frame being analyzed. The report also summarizes the factors that led to the addition or exclusion of each feature or feature option of the process as. When the analysis is a comparison to a prior analysis, the report will clearly show the impact of changing one or more features or feature options on the efficient frontier of the process owner as shown in FIG. 9. Other reports graphically display the sensitivity of the optimal mix to changes in the different features and external factor prices for the different frames. After the user (20) has completed the review of displayed reports and the input regarding reports to print has been saved in the reports table (145) processing advances to a software block 404.

The software in block 404 retrieves the feature mix selected for transmission to the process management system database (30) from the process value table (151) and transmits it via a network (25) before advancing to a software block 405. The transmission of information by the software in block 404 could use the information developed in the prior stages of processing to activate bots to communicate the desired changes to those operating the relevant elements of value and report back as appropriate regarding progress toward implementing the new feature set. In any event, the software in block 405 checks the reports tables (155) to determine if any reports have been designated for printing. If reports have been designated for printing, then processing advances to a block 406 where the software in the block prepares and sends the designated reports to the printer (118). After the reports have been sent to the printer (118), processing advances to a software block 409. Alternatively, if the software in block 405 determines that no additional reports have been designated for printing, then processing advances to block 409.

The software in block 409 checks the system settings table (140) to see if the process optimization is being run in continuous mode. If it is being run in continuous mode, then processing returns to software block 204 and the processing described previously is repeated. Alternatively, if the processing is not being run in continuous mode, then processing advances to a software block 415 where processing stops.

Thus, the reader will see that the system and method described above transforms extracted transaction data and information into a specification of the optimal mix of features and feature options for a process. The optimal mix is the mix that maximizes expected value while minimizing risk for the process owner. The level of detail contained in the process specification enables the analysis and simulation of the impact of changes in the identified process on the future value and risk of the enterprise that owns the process.

While the above description contains many specificities, these should not be construed as limitations on the scope of the invention, but rather as an exemplification of one preferred embodiment thereof. Accordingly, the scope of the invention should be determined not by the embodiment illustrated, but by the appended claims and their legal equivalents.

1. A computer system that determines the optimal mix of features and feature options for a process from the perspective of the process owner, the system comprising:
means for obtaining process management data, external factor prices and the matrices of value and risk for the owner;
means for representing the impact of one or more process features and one or more process feature options on process deliverables;
means for mapping process deliverables to the matrices of value and risk for the owner;
means for optimizing the mix of process features and feature options from the perspective of the process owner;
means for displaying the optimal mix of process features and feature options.

2. The system of claim 1 where the real option segment of value is valued using Black Scholes algorithms.

3. The system of claim 1 where the matrix of value for the owner is subdivided in up to five segments of value, current operation, real options, derivatives, excess financial assets and market sentiment.

4. The system of claim 1 where the display of the optimal mix includes a graphic display of the impact of the optimized process on the efficient frontier of the process owner.

5. The system of claim 1 further comprising the use of optimization algorithms for determining the optimal mix of features and feature options.

6. The system of claim 1 further comprising the use of genetic algorithms for determining the optimal mix of features and feature options.

7. The system of claim 1 further comprising the optional use of simulation system data to represent the impact of one or more features and one or more feature options on process deliverables.

8. The system of claim 1 where the matrix of risk for the owner is subdivided in up to five segments: current operation, real options, derivatives, excess financial assets and market sentiment.

9. The system of claim 1 where the matrix of risk for the owner includes risk from element variability, risk from external factor variability and event risk.

10. The system of claim 1 where the matrix of risk for the owner includes risk from element variability, risk from external factor variability and event risk by segment of value.

11. A data processing method for operating a process to maximize value to the owner:
obtaining the matrix of value and the matrix of risk for the owner of the process and external factor price information;
organizing process management information into resources, deliverables, one or more features and one or more feature options;
determining a contribution of each of one or more features to the process deliverables;
mapping the process deliverables, resources and features to the matrices of value and risk for the owner, and
optimizing the feature and feature option mix to maximize process value from the perspective of the owner.

12. A computer readable medium having computer executable instructions thereon for causing a computer to perform the method of claim 11.

13. A method for determining the optimal mix of features and feature options for a process from the perspective of the process owner, the system comprising:
obtaining process management data, external factor prices and the matrices of value and risk for the owner;
representing the impact of one or more features and one or more feature options on process deliverables;
mapping the expected process outputs to the matrices of value and risk for the owner;
optimizing the mix of process features and feature options from the perspective of the process owner;
displaying the optimal mix of process features and feature options.

14. The method of claim 13 where the real option segment of value is valued using Black Scholes algorithms.

15. The method of claim 13 where the matrix of value for the owner is subdivided in up to five segments of value, current operation, real options, derivatives, excess financial assets and market sentiment.

16. The method of claim 13 where the display of the optimal mix includes a graphic display of the impact of the optimized process on the efficient frontier of the process owner.

17. The method of claim 13 further comprising the use of optimization algorithms for determining the optimal mix of features and feature options.

18. The method of claim 13 further comprising the use of genetic algorithms for determining the optimal mix of features and feature options.

19. The method of claim 13 further comprising the optional use of simulation system data to represent the impact of one or more features and one or more feature options on process deliverables.

20. The method of claim 13 where the matrix of risk for the owner is subdivided in up to five segments: current operation, real options, derivatives, excess financial assets and market sentiment.

21. The method of claim 13 where the matrix of risk for the owner includes risk from element variability, risk from external factor variability and event risk.

22. The method of claim 13 where the matrix of risk for the owner includes risk from element variability, risk from external factor variability and event risk by segment of value.

23. A computer readable medium having computer executable instructions thereon for causing a computer to perform the method of claim 13.
